(19) United States
(12) Patent Application Publication
(10) Pub. No.: US 2007/0226982 A1
(43) Pub. Date: Oct. 4, 2007

(54) JOINING PROCESS, STAMPING APPARATUS AND ASSOCIATED DIE

(76) Inventors: Christian Reiter, Giessen (DE); Ruben Gutierrez, Wetzlar (DE); Paul Bartig, Linden (DE)

Correspondence Address: MILES & STOCKBRIDGE PC, 1751 PINNACLE DRIVE, SUITE 500, MCLEAN, VA, 22102-3833, US

(21) Appl. No.: 11/687,971

(22) Filed: Mar. 19, 2007

(30) Foreign Application Priority Data
Mar. 17, 2006 (DE) 10 2006 013 938.0

(51) Int. Cl. B23P 11/00

(52) U.S. Cl. 29/432.1

(57) ABSTRACT

A process for connecting at least two workpieces forming a workpiece arrangement, by means of a joining element having at least one radial recess, the joining element being driven axially into the workpiece arrangement while the workpiece arrangement is supported in the axial direction by a hollow die, so that at least one workpiece trimming is forced into the die. A deformation force is exerted on at least one of the workpieces to press material of a workpiece into the radial recess, thereby to set up a positive locking connection between the joining element and a workpiece. The die has a holding structure to hold a workpiece trimming securely in place, so that the workpiece trimming remains in the die when the die and the workpiece arrangement are separated from one another.

### CROSS-REFERENCE TO RELATED APPLICATION

This application claims the benefit of German Patent Application No. 10 2006 013 938.0 filed Mar. 17, 2006, incorporated herein by reference.

### BACKGROUND OF THE INVENTION

The present invention relates to a process for connecting at least two workpieces, which form a workpiece arrangement, by means of a joining element which has at least one radial recess, the joining element being driven axially into the workpiece arrangement while the workpiece arrangement is being supported in the axial direction by means of a hollow die, so that at least one workpiece trimming is forced outwards into the hollow die, and a deformation force being exerted on at least one of the workpieces in order to press material of the workpiece into the radial recess, thereby to set up a positive locking connection between the joining element and the workpiece.

The invention also relates to a stamping apparatus, which is suitable in particular for carrying out a process of this type, and to a die for such stamping apparatus.

A known example of a joining process of the generic type is what is known as self-piercing riveting using a solid self-piercing rivet as the joining element. In this case, at least two workpieces, for example metal sheets, forming a workpiece arrangement are clamped by a die and a blank holder. A solid self-piercing rivet is pressed through the workpieces so as to stamp its way through by means of a joining punch (riveting punch). The workpiece trimmings which have been cut out in this way (i.e. the cuttings) are discharged downwards. The solid self-piercing rivet completely fills the hole which is formed. Towards the end of the operation, the axial force exerted on the workpiece arrangement is increased, and a punching ring, arranged for example on the die, produces an undercut, which is required for the strength of connection (positive locking in the axial direction), by pressing material of the workpiece arrangement into the radial recess.

Self-piercing riveting by means of a solid self-piercing rivet differs from self-piercing riveting by means of a semi-hollow rivet by virtue of the fact that the solid self-piercing rivet is not substantially deformed during the stamping operation. Furthermore, the solid self-piercing rivet extends over substantially the entire thickness of the workpiece arrangement.

Self-piercing riveting using a solid self-piercing rivet and using a semi-hollow rivet is described, for example, in the document “Fügen durch Umformen-Nieten und Durchsetzfügen-lnnovative Verbindungsverfahren fur die Praxis” [Joining by Deformation—Riveting and Clinching—Innovative Connection Processes for Practical Applications], documentation 707 from Studiengesellschaft Stahlanwendungen e.V., O.Hahn, U.Klemens, 1996.

Document DE 298 22 745 discloses a self-piercing rivet which can be used to carry out the process of the generic type. The contour of the radial recess (annular groove) of this known self-piercing rivet is asymmetrical in shape.

Document EP 1 054 169 A2 discloses a self-piercing rivet which has a plurality of encircling annular grooves.

U.S. Pat. No. 4,130,922 discloses a punching ring which is provided with a concave annular groove over virtually the entire axial length; material of both workpieces can be pressed into this groove.

Furthermore, U.S. Pat. No. 4,978,270 discloses a self-piercing rivet having a plurality of radial grooves in order to connect more than two workpieces to each another.

To ensure that the workpiece trimmings which have been severed (the cuttings) are discharged in a suitable way, the hollow die is often designed in such a way as to widen conically. In this way, disruption-free discharge of the workpiece trimmings can be ensured.

### BRIEF DESCRIPTION OF THE INVENTION

In view of the above background, it is an object of the present invention to provide an improved joining process and an improved stamping apparatus and an associated die, in which, in particular, the removal of a workpiece trimming is improved.

This object is achieved by virtue of the fact that a hollow die is constructed so as to ensure that a workpiece trimming, which has been introduced into the hollow die, is held securely in place, so that the workpiece trimming remains in the hollow die when the die and the workpiece arrangement are separated from one another.

This makes it possible to prevent the workpiece trimming (i.e., the cutting) from sticking when the workpiece arrangement, with the joining element remaining therein, is lifted off the die.

This sticking of the workpiece trimming which has been cut off can occur because of adhesion forces, for example, if fluids are used, and, for example, if adhesives are used as in the automotive industry.

The present invention can be used for what are known as hybrid joining processes, in which adhesives are used in addition to the mechanical joining process. The adhesives, in addition to the joining task can, for example, also perform a sealing and galvanic separation function. This may be important in particular if different materials, such as steel or aluminium, are being connected to one another by joining elements such as solid self-piercing rivets.

Adhesives can be applied to the joining flange in the form of beads. To ensure that the joining flange is sealed, there may be a slight excess of adhesive, with the result that adhesive can escape over the edge of the workpieces.

A die according to the invention can also be used for other types of stamping apparatuses or cutting apparatuses, for example for punching tools. The die according to the invention can in this case be used to prevent cuttings from sticking to a punch.

The present invention allows a workpiece trimming which has been cut off to be discharged by a reliable process. Therefore, there may be no need for process monitoring means, such, as for example optical monitoring, or for a blast of compressed air. Means of this type might otherwise be used to prevent the workpiece trimmings which have been cut out from sticking to the underside of the punch or the joining element, since a sticking workpiece trimming could come loose in an uncontrolled way, in particular during joining operations carried out at a later stage, causing disruption or damage and thereby leading to quality problems.

It is particularly beneficial if the workpiece trimming has a first partial trimming from a workpiece, from the side of which the joining element is driven in, and a second partial trimming, and if the construction causes the first partial trimming to be held in place.

This can ensure that the first partial trimming to be held on the die when the workpiece arrangement is separated from the die. Other (lower) partial trimmings can then either likewise be held in place or can be separated from the first partial trimming, so that they can be disposed of via the hollow die.

Trimming holding means can be configured in different ways, for example by means of elastic means mounted on the die.

The hollow die can have a hollow portion, the internal diameter of which is matched to the external diameter of a workpiece trimming, and a holding projection can protrude inwards from the hollow portion, so as to form a narrow region into which the workpiece trimming is pressed.

This generally requires a slightly higher force to press through a workpiece trimming. The narrow region can cause the workpiece trimming to be deformed, so that it is held in a clamping manner at the narrow region. It will be understood that the clamping force which can be set by means of the holding projection should be set sufficiently high for it to exceed any holding force produced by adhesive or the like between the joining element and the workpiece trimming.

The holding projection can be an annular projection. An annular projection is easy to produce, in particular if the die is rotationally symmetrical in form. It is advantageous if the annular projection is constructed to be continuous all the way around.

According to a further embodiment, the annular projection can have a portion which is constructed to taper conically in the joining direction. This makes it possible to securely wedge the workpiece trimming against the holding projection.

According to a further embodiment, the annular projection can have a portion which is constructed to widen conically in the joining direction. This also allows the workpiece trimming to be securely wedged in place.

According to a further embodiment, the annular projection can have a portion with a convex cross-section. An annular projection of this type is easy to realize in design terms and inexpensive to produce.

It is advantageous if the clear width of the narrow region is less than or equal to the external dimension of the joining element. This makes it possible to ensure that a workpiece trimming is plastically deformed, so that a defined holding force can be achieved.

As mentioned earlier, the holding means can be provided with elastic means in order to hold the workpiece trimming on the hollow die.

Furthermore, in a joining process according to the invention it is advantageous if the workpiece trimming held by the holding means is displaced by a further workpiece trimming in a subsequent joining operation. The workpiece trimming which was previously held is consequently pressed beyond the holding means and can then be discharged via the hollow die. The further workpiece trimming is held by means of the holding means.

It is of particular benefit if the hollow die is open at the bottom, so that a displaced workpiece trimming is discharged via the open bottom.

Although in general terms it is also conceivable for the workpiece trimmings to be disposed of from the hollow die in the opposite direction to the joining direction, disposal in the joining direction is advantageous because it is easier to establish continuous operation.

According to a further embodiment, the joining element has a head which engages one of the workpieces, in such a manner that after the joining operation the workpieces are fixed in a positive locking manner between the head and the positive locking connection at the radial recess. With this embodiment, it is sufficient, for example, for a radial recess to be arranged at the joining element in such a way that only material of one of the workpieces (the workpiece lying opposite the head) penetrates into the radial recess.

Features of a joining process of the invention can be used in stamping apparatus according to the invention and in a die according to the invention.

### BRIEF DESCRIPTION OF THE DRAWINGS

The invention will be further described in conjunction with the accompanying drawings, which illustrate preferred (best mode) embodiments, and wherein:

FIG. 1 shows a sequence of process steps in a joining operation using a solid self-piercing rivet according to the prior art;

FIG. 2 diagrammatically depicts an alternative configuration of a solid self-piercing rivet according to the prior art;

FIG. 3 shows a half-section view of a die according to the invention, which can be used for example for a joining process according to the invention;

FIG. 4 shows an illustration corresponding to FIG. 3 with a workpiece trimming which has been introduced into the die according to the invention;

FIG. 5 shows an illustration corresponding to FIG. 4, with a first partial trimming of the workpiece trimming from FIG. 4 held at holding means of the die;

FIG. 6 shows a detail view corresponding to excerpt VI from FIG. 3, showing an alternative configuration of an annular projection;

FIG. 7 shows a detail view corresponding to excerpt VI from FIG. 3, showing a further alternative embodiment of an annular projection;

FIG. 8 shows a detail view corresponding to excerpt VI from FIG. 3, showing a further alternative configuration of an annular projection; and

FIG. 9 shows a diagrammatic perspective view of a further die according to the invention with a further configuration of holding means in the form of individual projections.

### DETAILED DESCRIPTION OF THE INVENTION

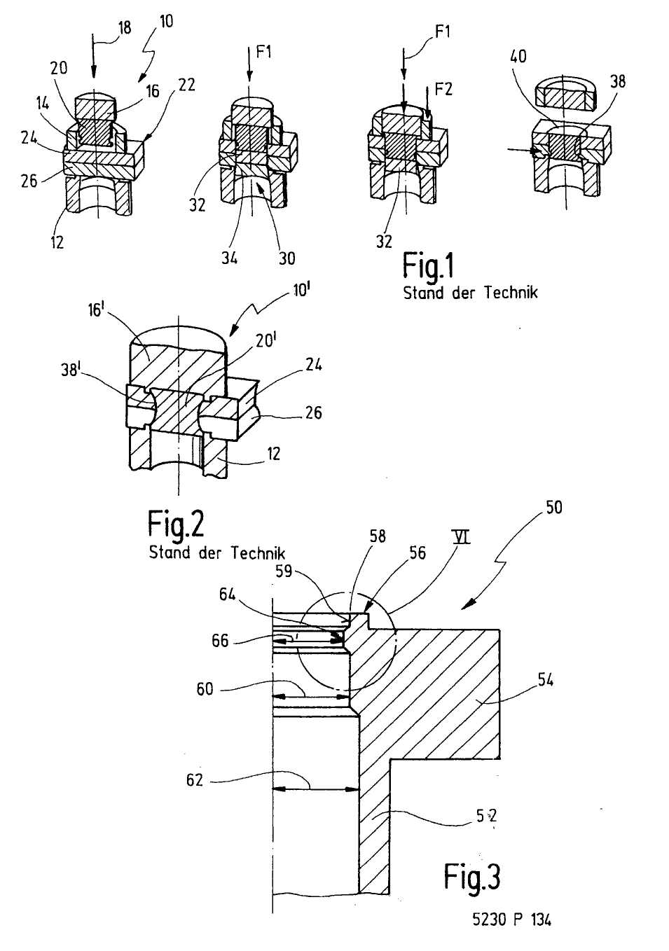

FIG. 1 diagrammatically depicts a joining operation carried out by self-piercing riveting using a solid self-piercing rivet according to the prior art. The figure shows four process steps, which take place in succession, in terms of time, in the order from left to right.

FIG. 1 also diagrammatically depicts a joining apparatus 10 in the form of a self-piercing riveting apparatus, having a hollow die 12 and a blank holder 14. Furthermore, the stamping device 10 has a joining punch 16, which can move in a joining direction 18, in order to press a joining element 20 (solid self-piercing rivet) into a workpiece arrangement 22 comprising a plurality of workpieces (in this case a first workpiece 24 and a second workpiece 26).

During the joining operation, the workpiece arrangement 22, for example an arrangement of two or more metal sheets, is clamped between the die 12 and the blank holder 14, which is likewise hollow in form.

Then, the joining element is forced through the blank holder 14 into the workpiece arrangement 22 by means of the joining punch 16.

The front edge of the joining element 20 is configured as a cutting edge, so that the joining element 20 is pressed into the workpiece arrangement 22 with a stamping action.

This is shown in the middle two illustrations of FIG. 1, in which a workpiece trimming (cutting) 30 is separated from the workpiece arrangement 22, the workpiece trimming 30 comprising a first partial trimming 32 from the first (upper) workpiece 24 and a second partial trimming 34 from the second workpiece 26.

A force F1 is exerted on the joining element 20 until a top side of the joining element 20 is approximately flush with the top side of the upper workpiece 24. Then, a force F2 on the blank holder 14 is increased and a punching ring provided at the top side of the die 12 is pressed into the lower workpiece 26 from below.

The joining element 20 has a radially encircling radial recess 38 in the form of an annular groove, into which material of the second workpiece 26 is pressed. As a result, a positive locking connection between the joining element 20 and the second workpiece 26 is produced at this location.

In the present context, the term positive locking connection is to be understood in a broad context, such that material of the workpiece arrangement 22 penetrates radially into a radial recess in the joining element 20 so as to produce an undercut.

At its top side, onto which the joining punch 16 is pressed, the joining element 20 has a head, for example in the form of a countersunk head, which also produces a positive locking connection to the first workpiece 24 in the above sense.

In this way, after the joining operation, the two workpieces 24, 26 are connected to one another in a positive locking manner between the head 40 and the positive locking connection at the radial recess 38.

FIG. 2 shows an alternative configuration of a joining apparatus 10′, the joining element 20′ having an alternative configuration of a radial recess 38′. The radial recess 38′ is designed in the form of an annular groove, into which material of both workpieces 24, 26 is pressed. This type of stamping apparatus 10′ also forms part of the general prior art.

FIG. 3 shows a die 50 according to the invention which can be used instead of the die 12 in the stamping apparatuses 10, 10′ shown in FIGS. 1 and 2.

The die 50 has a tubular portion 52 and an adjoining supporting portion 54, which is constructed in the form of a flange.

A punching ring 56, which can be used to press material into the radial groove 38, 38′ in the joining element 20, 20′, is provided at the top side of the supporting portion 54 on which the lower workpiece 26 rests during the joining operation.

A cutting edge 58, past which the workpiece trimming 30 is forced with a shearing action, is provided radially inside the punching ring 56. The cutting edge 58 is adjoined by a hollow portion 59, the cutting edge radius 60 of which is matched to the diameter of the workpiece trimming 30 that is stamped out.

A holding projection 64, which is approximately trapezoidal in cross section, with a conically narrowing portion and a conically widening portion, is provided in the hollow portion 59 at an axial distance from the cutting edge 58. The internal radius 66 in the region of the holding projection 64 is smaller than the cutting edge radius 60 and consequently a workpiece trimming 30 which is pressed into the hollow portion 59 is plastically deformed by means of the holding projection 64, so that it is held clamped against the holding projection 64.

When the joined workpiece arrangement 22 is lifted off, the workpiece trimming 30 consequently remains inside the hollow die 50, even if adhesive or other viscous substances, which could cause the workpiece trimming 30 to be lifted up together with the workpiece arrangement 22 due to adhesive forces, are present between the workpiece trimming 30 and the joining element 20.

FIG. 3 also shows that an enlarged tube portion radius 62, which is larger than the cutting edge radius 60, is present in the region of the tube portion 52, in order to make it easy for workpiece trimmings 30 to be discharged downwards through the hollow die 50.

The arrangement of the holding projection 64 is configured in such a way that the upper, first partial trimming 32 of the workpiece trimming 30 is held by the holding projection 64. The lower partial trimming 34 can then be discharged downwards through the tube portion 52.

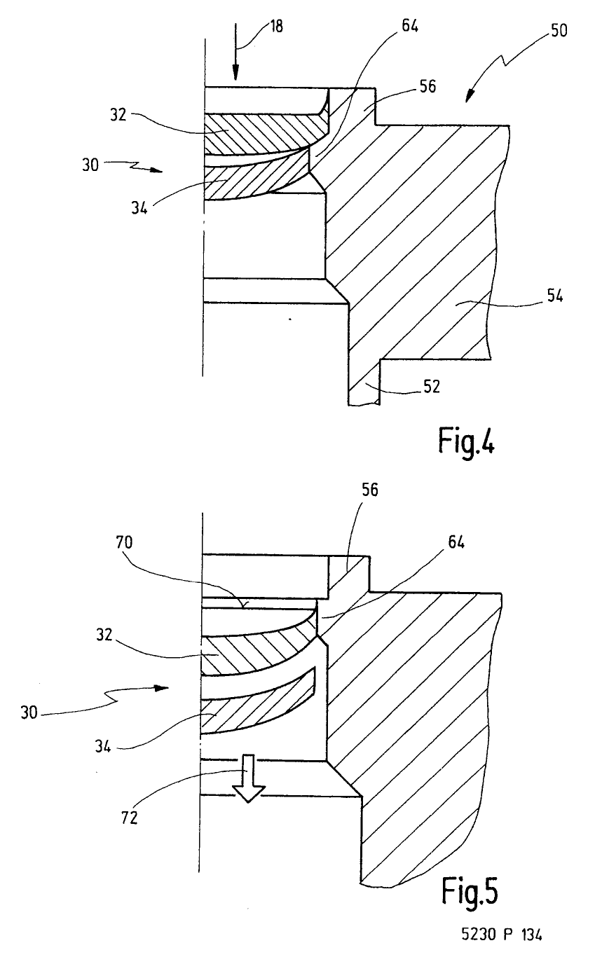

FIG. 4 shows how the workpiece trimming 30 is pressed into the hollow die 50 by means of the force F1 in direction 18. First of all, the lower, second partial trimming 34 of the workpiece trimming 30 is deformed and pressed into the holding projection 64. As the operation continues, the first partial trimming 32 is then pressed into the holding projection 64, so that the first partial trimming 32 is plastically deformed and consequently held clamped against the holding projection 64 (FIG. 5).

It can be seen that it is possible for the partial trimmings 32, 34 to bend with respect to their plane, with the result that surface-to-surface contact between the top side of the first partial trimming 32 and the underside of the joining element 20 is substantially avoided. However, this is merely a preferred configuration. Even with surface-to-surface contact, the holding projection 64 can ensure that the first partial trimming 32 remains in the hollow die 54 even if adhesive were to have penetrated between the first partial trimming 32 and the joining element 20. FIG. 5 shows the state in which the first partial trimming 32 is held against the holding projection 64.

During a subsequent joining operation, this first partial trimming 32 is displaced downwards past the holding projection 64, by means of a second partial trimming 34 of a further workpiece trimming 30.

In FIG. 5, the underside of the joining element 20 is shown for example at 70. FIG. 5 also shows that workpiece trimmings 30 can be disposed of downwards through the tube portion, in a disposal direction 72.

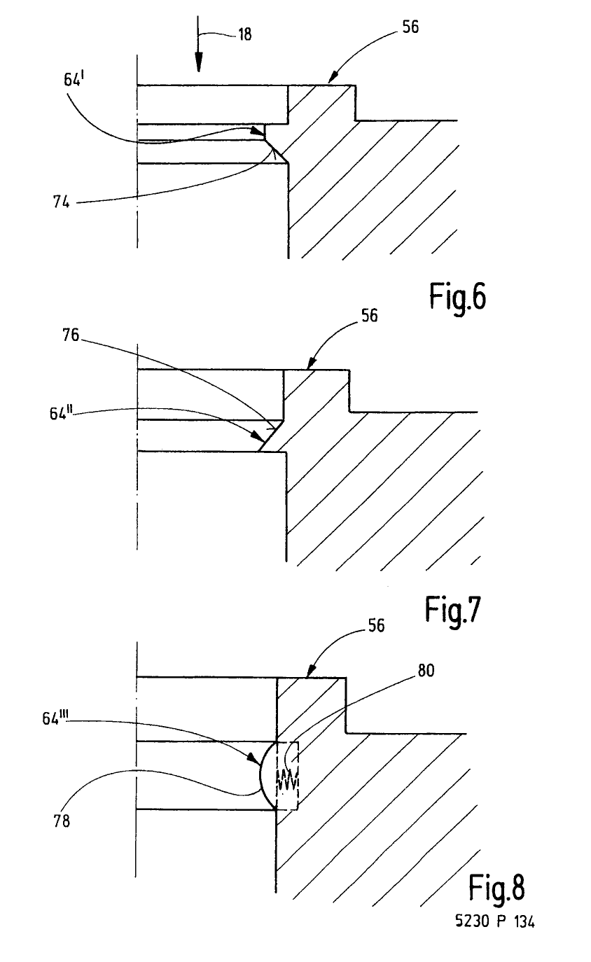

FIGS. 6 to 9 show alternative embodiments of holding means for holding a workpiece trimming 30 in the hollow die 50. The holding means are preferably configured as holding projections.

For example, FIG. 6 shows a holding projection 64′ which has a conically widening portion 74 on its underside.

FIG. 7 shows an alternative embodiment of a holding projection 64, which has a conically tapering section 76 on its top side.

Finally, FIG. 8 shows a holding projection 64′″ which is convex in cross-section.

In all cases, the holding projections can be formed as annular projections, either running continuously all the way around or interrupted in parts.

FIG. 8 also shows that elastic means 80 may be provided in order to hold a workpiece trimming 30 at the hollow die 50.

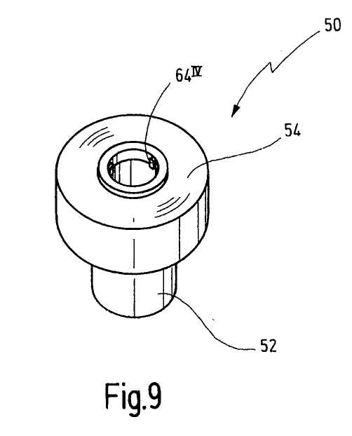

FIG. 9 shows an embodiment in which a number of (in the present case three) individual holding projections 64^{IV} are provided at the hollow portion 59 instead of one encircling annular projection.

If an inverted wedge as shown in FIG. 6 is used and if a wedge shape with a conically tapering portion 76 (FIG. 7) is used, it is possible to securely wedge the workpiece trimming 30 in place.

The round, convex portion 78 of FIG. 8 allows the workpiece trimming 30 to be pressed through but also ensures that it is separated from the underside of the joining element 20.

While preferred embodiments have been shown and described, it will be apparent that changes can be made without departing from the principles and spirit of the invention, the scope of which is defined in the following claims.

What is claimed is:

1. A process for connecting at least two workpieces, which form a workpiece arrangement, by means of a joining element which has at least one radial recess, the joining element being driven axially into the workpiece arrangement while the workpiece arrangement is being supported in the axial direction by means of a hollow die, so that at least one workpiece trimming is forced into the hollow die, and a deformation force being exerted on at least one of the workpieces in order to press material of the at least one workpiece into the radial recess, thereby to set up a positive locking connection between the joining element and the at least one workpiece,
characterized in that
the hollow die is provided with holding means to hold the at least one workpiece trimming securely in the hollow die, so that the held at least one workpiece trimming remains in the hollow die when the die and the workpiece arrangement are separated from one another.

2. The joining process according to claim 1, characterized in that the at least one workpiece trimming includes a first partial trimming of one of the workpieces, from the side of which the joining element is driven in, and a second partial trimming from another of the workpieces, and in that the holding means is arranged in such a way that the first partial trimming is held securely in place.

3. The joining process according to claim 1, characterized in that the hollow die has a hollow portion, the internal diameter of which is matched to the external diameter of the workpiece trimming, and in that the holding means has a holding projection that protrudes inwardly from the hollow portion, so as to form a narrow region into which the workpiece trimming is pressed.

4. The joining process according to claim 3, characterized in that the holding projection is an annular projection.

5. The joining process according to claim 4, characterized in that the annular projection is formed continuously all the way around.

6. The joining process according to claim 3, characterized in that the annular projection has a portion that tapers conically in a joining direction.

7. The joining process according to claim 3, characterized in that the annular projection has a portion that widens conically in a joining direction.

8. The joining process according to claim 3, characterized in that the annular projection has a portion with a convex cross-section.

9. The joining process according to claims 3, characterized in that the clear width of the narrow region is less than or equal to the external dimension of the joining element.

10. The joining process according to claim 1, characterized in that the holding means has elastic means for holding the at least one workpiece trimming on the hollow die.

11. The joining process according to claim 1, characterized in that the at least one workpiece trimming held by the holding means is displaced by a further workpiece trimming in a subsequent joining operation.

12. The joining process according to claim 11, characterized in that the hollow die is open towards the bottom, so that a displaced workpiece trimming is discharged via an opening at the bottom.

13. The joining process according to claim 1, characterized in that the joining element has a head, which engages one of the workpieces, in such a manner that after the joining operation the workpieces are fixed in a positive locking manner between the head and the positive locking connection at the radial recess.

14. A stamping apparatus for carrying out a joining process for joining at least a pair of workpieces in a workpiece arrangement, comprising:
a hollow die,
a punch displaceable in an axial direction of the die, with the workpiece arrangement between the punch and the die, and
a joining element disposed to be driven into the workpiece arrangement by the punch so that at least one workpiece trimming is forced into the hollow die,
characterized in that
the hollow die has holding means constructed to hold a workpiece trimming forced into the hollow die, so that at least one workpiece trimming remains in the hollow die when the die and the workpiece arrangement are separated from one another.

15. A stamping apparatus according to claim 14, characterized in that the hollow die has a hollow portion, the internal diameter of which is matched to the external diameter of the workpiece trimming, and in that the holding means has a holding projection that protrudes inwardly from the hollow portion, so as to form a narrow region into which the workpiece trimming is pressed.

16. A stamping apparatus according to claim 14, characterized in that the hollow die is open towards the bottom, so that a displaced workpiece trimming can be discharged from the die via an opening at the bottom.

17. A die for use in stamping apparatus or the like, the die being hollow and having holding means constructed to hold a trimming inserted from a workpiece, so that the trimming remains in the die when the die and the workpiece are separated from another.

18. A die according to claim 17, characterized in that the holding means has a holding projection that protrudes inwardly so as to form a narrow region into which the trimming is pressed.

19. A die according to claim 18, characterized in that the holding projection is an annular projection that is continuous or interrupted.

20. A die according to claim 19, characterized in that the annular projection has a portion that narrows along an insertion direction of the trimming.

21. A die according to claim 19, characterized in that the annular projection has a portion that widens along an insertion direction of the trimming.

22. A die according to claim 17, characterized in that the holding means is elastic.

23. A die according to claim 17, characterized in that the hollow die is open towards the bottom, so that a trimming can be discharged from the die via an opening at the bottom.
